(19) United States
(12) Patent Application Publication
(10) Pub. No.: US 2011/0301299 A1
(43) Pub. Date: Dec. 8, 2011

(54) Medical Devices and Polymers Therefor Having PTFE Surfaces Modified With Nitric Oxide-Releasing Polymers

(75) Inventor: Mingfei Chen, Santa Rosa, CA (US)

(73) Assignee: Medtronic Vascular, Inc., Santa Rosa, CA (US)

(21) Appl. No.: 12/796,301

(22) Filed: Jun. 8, 2010

(51) Int. Cl. C08F 214/26

(52) U.S. Cl. 525/326.4; 525/326.2

(57) ABSTRACT

Described herein are polymers useful for forming or coating implantable medical devices and such medical devices. The polymers are biocompatible and hemocompatible and comprise PTFE surfaces modified by covalently linking a nitric oxide releasing polymer to the PTFE surface through a linking group. Further described are precursor polymers and processes for preparing such polymers and precursor polymers.

### FIELD OF THE INVENTION

The present invention relates to medical devices and biocompatible and hemocompatible polymers therefor comprising PTFE surfaces that have been modified by covalently bonding nitric oxide releasing polymers thereto through a linking group.

### BACKGROUND OF THE INVENTION

PTFE, particularly microporous expanded PTFE (ePTFE) is widely used as a medical device material, both for construction and for coating of medical devices, in part because of its excellent biocompatibility and inert nature. However, when used in a hemodynamic environment, such as a covering for a stent graft or as a vascular graft material, PTFE surfaces present undesirable properties such as the inability to promote endothelial cell adhesion and ingrowth and, as a result, a tendency to encourage formation of thrombi.

As a result, much attention has been given to modifying PTFE surfaces to make them more hemocompatible. Such techniques have included, for example, endothelial cell seeding, graft pre-treatment with endothelial cell mitogens, increasing structural porosity, coating the surface with a protein matrix, and plasma treatment to form a covalent bond between the PTFE surface and the modifier, either directly or through a spacer molecule. Modifiers that have been used include, for example, heparin, choline, phosphorylcholine, polysaccharides, polyethylene glycol, and a variety of bioactive agents. See, for example, U.S. Pat. Nos. 5,830,539, 5,945,457 and 7,597,924, and European Patent No. EP1368075B1. While these molecules improve hemocompatibility of the PTFE surface and reduce the tendency for thrombus formation, they do not, by themselves, necessarily encourage endothelial cell adhesion or ingrowth.

Nitric oxide (NO) is a simple diatomic molecule that plays a diverse and complex role in cellular physiology. Less than 25 years ago NO was primarily considered a smog component formed during the combustion of fossil fuels mixed with air. However, as a result of the pioneering work of Ferid Murad et al. it is now known that NO is a powerful signaling compound and cytotoxic/cytostatic agent found in nearly every tissue including endothelial cells, neural cells and macrophages. Mammalian cells synthesize NO using a two step enzymatic process that oxidizes L-arginine to N-ω-hydroxy-L-arginine, which is then converted into L-citrulline and an uncharged NO free radical. Three different nitric oxide synthase enzymes regulate NO production. Neuronal nitric oxide synthase (NOSI, or nNOS) is formed within neuronal tissue and plays an essential role in neurotransmission; endothelial nitric oxide synthase (NOS3 or eNOS), is secreted by endothelial cells and induces vasodilatation; inducible nitric oxide synthase (NOS2 or iNOS) is principally found in macrophages, hepatocytes and chondrocytes and is associated with immune cytotoxicity.

Neuronal NOS and eNOS are constitutive enzymes that regulate the rapid, short-term release of small amounts of NO. In these minute amounts NO activates guanylate cyclase which elevates cyclic guanosine monophosphate (cGMP) concentrations which in turn increase intracellular Ca⁺² levels. Increased intracellular Ca⁺² concentrations result in smooth muscle relaxation which accounts for NO's vasodilating effects. Inducible NOS is responsible for the sustained release of larger amounts of NO and is activated by extracellular factors including endotoxins and cytokines. These higher NO levels play a key role in cellular immunity.

Medical research is rapidly discovering therapeutic applications for NO including the fields of vascular surgery and interventional cardiology. Procedures used to clear blocked arteries such as percutaneous transluminal coronary angioplasty (PTCA) (also known as balloon angioplasty) and atherectomy and/or stent placement can result in vessel wall injury at the site of balloon expansion or stent deployment. In response to this injury a complex multi-factorial process known as restenosis can occur whereby the previously opened vessel lumen narrows and becomes re-occluded. Restenosis is initiated when thrombocytes (platelets) migrating to the injury site release mitogens into the injured endothelium. Thrombocytes begin to aggregate and adhere to the injury site initiating thrombogenesis, or clot formation. As a result, the previously opened lumen begins to narrow as thrombocytes and fibrin collect on the vessel wall. In a more frequently encountered mechanism of restenosis, the mitogens secreted by activated thrombocytes adhering to the vessel wall stimulate overproliferation of vascular smooth muscle cells during the healing process, restricting or occluding the injured vessel lumen. The resulting neointimal hyperplasia is the major cause of stent restenosis.

Recently, NO has been shown to significantly reduce thrombocyte aggregation and adhesion; this combined with NO's directly cytotoxic/cytostatic properties may significantly reduce vascular smooth muscle cell proliferation and help prevent restenosis. Thrombocyte aggregation occurs within minutes following the initial vascular insult and once the cascade of events leading to restenosis is initiated, irreparable damage can result. Moreover, the risk of thrombogenesis and restenosis persists until the endothelium lining the vessel lumen has been repaired. Therefore, it is essential that NO, or any anti-restenotic agent, reach the injury site immediately.

One approach for providing a therapeutic level of NO at an injury site is to increase systemic NO levels prophylactically. This can be accomplished by stimulating endogenous NO production or using exogenous NO sources. Methods to regulate endogenous NO release have primarily focused on activation of synthetic pathways using excess amounts of NO precursors like L-arginine, or increasing expression of nitric oxide synthase (NOS) using gene therapy. U.S. Pat. Nos. 5,945,452, 5,891,459 and 5,428,070 describe sustained NO elevation using orally administrated L-arginine and/or L-lysine. However, these methods have not been proven effective in preventing restenosis. Regulating endogenously expressed NO using gene therapy techniques remains highly experimental and has not yet proven safe and effective. U.S. Pat. Nos. 5,268,465, 5,468,630 and 5,658,565, describe various gene therapy approaches.

Exogenous NO sources such as pure NO gas are highly toxic, short-lived and relatively insoluble in physiological fluids. Consequently, systemic exogenous NO delivery is generally accomplished using organic nitrate prodrugs such as nitroglycerin tablets, intravenous suspensions, sprays and transdermal patches. The human body rapidly converts nitroglycerin into NO; however, enzyme levels and co-factors required to activate the prodrug are rapidly depleted, resulting in drug tolerance. Moreover, systemic NO administration can have devastating side effects including hypotension and free radical cell damage. Therefore, using organic nitrate prodrugs to maintain systemic therapeutic blood levels is not currently possible.

Therefore, considerable attention has been focused on localized, or site specific, NO delivery to ameliorate the disadvantages associated with systemic prophylaxis. Implantable medical devices and/or local gene therapy techniques including medical devices coated with NO-releasing compounds, or vectors that deliver NOS genes to target cells, have been evaluated. Like their systemic counterparts, gene therapy techniques for the localized NO delivery have not been proven safe and effective. There are still significant technical hurdles and safety concerns that must be overcome before site-specific NOS gene delivery will become a reality.

However, significant progress has been made in the field of localized exogenous NO application. To be effective at encouraging healthy endothelial function or preventing restenosis an inhibitory therapeutic such as NO must be administered for a sustained period at therapeutic levels. Consequently, any NO-releasing medical device must be suitable for implantation. Ideal candidate devices are vascular stents, stent-grafts and vascular grafts. Therefore, such devices that safely provide therapeutically effective amounts of NO to a precise location would represent a significant advance in treatment and prevention of restenosis and/or thrombotic events.

Nitric oxide-releasing compounds suitable for in vivo applications have been developed by a number of investigators. As early as 1960 it was demonstrated that nitric oxide gas could be reacted with amines to form NO-releasing anions having the following general formula: R—R′N—N(O)NO wherein R and R′ are ethyl. Salts of these compounds could spontaneously decompose and release NO in solution. (R. S. Drago et al., J. Am. Chem. Soc. 1960, 82:96-98)

Nitric oxide-releasing compounds with sufficient stability at body temperatures to be useful as therapeutics were ultimately developed by Keefer et al. as described in U.S. Pat. Nos. 4,954,526, 5,039,705, 5,155,137, 5,212,204, 5,250,550, 5,366,997, 5,405,919, 5,525,357 and 5,650,447 and in J. A. Hrabie et al., J. Org. Chem. 1993, 58:1472-1476, all of which are herein incorporated by reference.

Briefly, Hrabie et al. describes NO-releasing intramolecular salts (zwitterions) having the general formula: RN[N(O)NO⁻ (CH₂)ₓ NH₂⁺R′.

The [N(O)NO]⁻— (abbreviated hereinafter as NONO) containing compounds thus described release NO via a first-order reaction that is predictable, easily quantified and controllable (See FIG. 2). This is in sharp contrast to other known NO-releasing compounds such as the S-nitrosothiol series as described in U.S. Pat. Nos. 5,380,758, 5,574,068 and 5,583,101. Stable NO-releasing compounds have been coupled to amine containing polymers. U.S. Pat. No. 5,405,919 (“the '919 patent”) describes biologically acceptable polymers that may be coupled to NO-releasing groups including polyolefins, such as polystyrene, polypropylene, polyethylene, polyterafluoroethylene and polyvinylidene, and polyethylenimine, polyesters, polyethers, polyurethanes and the like. Medical devices, such as arterial stents, stent grafts or vascular grafts composed of these polymers represent a potential means for the site-specific delivery of NO.

However, for example, the highly biocompatible and hydrophilic polyethylenimine disclosed in the '919 patent is water soluble, and thus not suitable for use as a coating for a medical device nor can polyethylenimine be used to fabricated implantable medical devices despite its high degree of biocompatibility.

Therefore, there remains a need for biocompatible and hemocompatible NO releasing polymers suitable for use in physiological, particularly hemodynamic, environments.

### SUMMARY OF THE INVENTION

Described herein are biocompatible and hemocompatible polymers adapted for use as implantable medical device materials, comprising a PTFE surface, a linking group covalently bound to said surface, and a nitric oxide releasing polymer, said polymer covalently bound to said linking group.

Further described herein are implantable medical devices comprising a biocompatible and hemocompatible polymer comprising a PTFE surface, a linking group covalently bound to said surface, and a nitric oxide releasing polymer, said polymer covalently bound to said linking group.

In one embodiment there are presented biocompatible and hemocompatible polymers, and implantable medical devices comprising such polymers, as described above, wherein the nitric oxide releasing polymer comprises diazeniumdiolated poly(ethyleneimine) or a copolymer of poly(vinyl alcohol) and diazeniumdiolated poly(vinyl acetate).

In another embodiment there are presented polymers comprising a PTFE surface, a linking group covalently bound to said surface, and a diazeniumdiolatable polymer, said polymer covalently bound to said linking group, wherein the diazeniumdiolatable polymer comprises poly(ethyleneimine) or a copolymer of poly(vinyl alcohol) and poly(vinyl acetate).

In another embodiment there are presented implantable medical devices comprising a polymer comprising a PTFE surface, a linking group covalently bound to said surface, and a diazeniumdiolatable polymer, said polymer covalently bound to said linking group, wherein the diazeniumdiolatable polymer comprises poly(ethyleneimine) or a copolymer of poly(vinyl alcohol) and poly(vinyl acetate).

In another embodiment are biocompatible and hemocompatible polymers, and implantable medical devices comprising such polymers, as described above, wherein the linking group has the formula —NH—C(O)—(CH₂)ₙ—C(O)—, wherein n is an integer of from 0 to 20 and wherein the nitrogen of the linking group is covalently bound to the PTFE surface.

In another embodiment are precursors to the above polymers, and implantable medical devices comprising such precursor polymers, wherein the linking group has the formula —NH—C(O)—(CH₂)ₙ—C(O)—, wherein n is an integer of from 0 to 20 and wherein the nitrogen of the linking group is covalently bound to the PTFE surface. Such precursor polymers are identical to the above-described polymers with the exception that they are not nitric oxide releasing, but instead are diazeniumdiolatable to form the above-described polymers.

In another embodiment are implantable medical devices comprising nitric oxide releasing polymers selected from the group consisting of stents, stent grafts and vascular grafts.

In another embodiment are implantable medical devices comprising diazeniumdiolatable polymers selected from the group consisting of stents, stent grafts and vascular grafts

In other embodiments the nitric oxide releasing polymer comprises at least one additional monomer unit.

In other embodiments the diazeniumdiolatable polymer comprises at least one additional monomer unit.

In another embodiment the biocompatible and hemocompatible polymers, and implantable medical devices comprising such polymers, further comprise an additional bioactive agent.

In another embodiment the diazeniumdiolatable polymers, and implantable medical devices comprising such polymers, further comprise an additional bioactive agent.

A further embodiment encompasses processes for preparing both the biocompatible and hemocompatible polymers comprising nitric oxide releasing polymers, and the precursor polymers comprising diazeniumdiolatable polymers.

### DETAILED DESCRIPTION OF THE INVENTION

Described herein are biocompatible and hemocompatible polymers adapted for use in implantable medical devices. Also described are implantable medical devices comprising such polymers. The biocompatible and hemocompatible polymers comprise a PTFE surface that has been modified by covalent attachment of a nitric oxide releasing polymer through a linking group. By means of such modification, the PTFE surface, which is known to present issues of thrombus formation when in a hemodynamic environment, is not only rendered more hemocompatible, but also, due to the in situ release of NO, actively promotes healthy endothelial function and endothelial ingrowth into and around the implanted medical device.

The biocompatible and hemocompatible polymers of this invention comprise a PTFE surface, a linking group covalently bound to said surface, and a nitric oxide releasing polymer, said polymer covalently bound to said linking group. The nitric oxide releasing polymer comprises a polymer having diazeniumdiolated ethyleneimine units and/or a copolymer having diazeniumdiolated vinyl acetate units together with vinyl alcohol units. The latter type of carbon-based diazeniumdiolated polymers are described in US Patent Publication 2009/0232863, which is incorporated by reference herein in its entirety. Further, the polymers described herein can be formed as a copolymer with one or more other monomers. The copolymer can be randomly assembled or can be a block copolymer wherein the polymer is formed with blocks of various monomers. One skilled in the art understands that copolymers can be fine tuned depending on, for example, monomer ratios, number of different monomers used (e.g. bipolymer, terpolymer), monomer hydrophobicity or hydrophilicity, monomer molecular weight, polymer molecular weight, catalyst used and polymerization temperature.

The additional monomer units when polymerized may form, for example, either a biostable, bioabsorbable or bioresorbable polymer depending on the desired rate of NO or drug release or the desired degree of polymer stability. Bioabsorbable polymers that can be used include poly(L-lactic acid), polycaprolactone, poly(lactide-co-glycolide), poly(hydroxybutyrate-co-valerate), polydioxanone, polyorthoester, polyanhydride, poly(glycolic acid), poly(D,L-lactic acid), poly(glycolic acid-co-trimethylene carbonate), polyphosphoester, polyphosphoester urethane, poly(amino acids), cyanoacrylates, poly(trimethylene carbonate), poly(iminocarbonate), copoly(ether-esters) (e.g. PEO/PLA), polyalkylene oxalates, polyphosphazenes and biomolecules such as fibrin, fibrinogen, cellulose, starch, collagen and hyaluronic acid.

Also, biostable polymers with a relatively low chronic tissue response such as polyurethanes, silicones, and polyesters could be used and other polymers could also be used if they can be dissolved and cured or polymerized on the medical device such as polyolefins, polyisobutylene and ethylene-alphaolefin copolymers; acrylic polymers and copolymers, ethylene-co-vinylacetate, polybutylmethacrylate, vinyl halide polymers and copolymers, such as polyvinyl chloride; polyvinyl ethers, such as polyvinyl methyl ether; polyvinylidene halides, such as polyvinylidene fluoride and polyvinylidene chloride; polyacrylonitrile, polyvinyl ketones; polyvinyl aromatics, such as polystyrene, polyvinyl esters, such as poly(vinyl acetate); copolymers of vinyl monomers with each other and olefins, such as ethylene-methyl methacrylate copolymers, acrylonitrile-styrene copolymers, ABS resins, and ethylene-vinyl acetate copolymers; polyamides, such as Nylon 66 and polycaprolactam; alkyd resins; polycarbonates; polyoxymethylenes; polyimides; polyethers; epoxy resins, polyurethanes; rayon; rayon-triacetate; cellulose, cellulose acetate, cellulose butyrate; cellulose acetate butyrate; cellophane; cellulose nitrate; cellulose propionate; cellulose ethers; and carboxymethyl cellulose.

Also described herein are precursor polymers and implantable medical devices comprising such precursor polymers. These polymers are identical to the polymers comprising nitric oxide releasing polymers, with the exception that they are not diazeniumdiolated, but instead are diazeniumdiolatable.

The linking group is a group of the formula —NH—C(O)—(CH₂)ₙ—C(O)—, wherein n is an integer of from 0 to 20 and wherein the nitrogen is covalently bound to the PTFE surface. More preferably, n is an integer of from 6-12. Most preferably, n is 8.

The biocompatible and hemocompatible polymers as well as the precursor polymers may additionally comprise a bioactive agent whose release rate and profile is determined by the nature of the polymer. Exemplary, non limiting examples of bioactive agents that can be incorporated into the polymers and polymeric coating presently described include anti-proliferatives including, but not limited to, macrolide antibiotics including FKBP-12 binding compounds, estrogens, chaperone inhibitors, protease inhibitors, protein-tyrosine kinase inhibitors, leptomycin B, peroxisome proliferator-activated receptor gamma ligands (PPARγ), hypothemycin, nitric oxide, bisphosphonates, epidermal growth factor inhibitors, antibodies, proteasome inhibitors, antibiotics, anti-inflammatories, anti-sense nucleotides and transforming nucleic acids. Drugs can also refer to bioactive agents including anti-proliferative compounds, cytostatic compounds, toxic compounds, anti-inflammatory compounds, chemotherapeutic agents, analgesics, antibiotics, protease inhibitors, statins, nucleic acids, polypeptides, growth factors and delivery vectors including recombinant micro-organisms, liposomes, and the like.

Exemplary FKBP-12 binding agents include sirolimus (rapamycin), tacrolimus (FK506), everolimus (certican or RAD-001), temsirolimus (CCI-779 or amorphous rapamycin 42-ester with 3-hydroxy-2-(hydroxymethyl)-2-methylpropionic acid as disclosed in U.S. patent application Ser. No. 10/930,487) and zotarolimus (ABT-578; see U.S. Pat. Nos. 6,015,815 and 6,329,386). Additionally, other rapamycin hydroxyesters as disclosed in U.S. Pat. No. 5,362,718 may be used in combination with the polymers described herein.

The nitrogen-based diazeniumdiolated polymers of the present invention may be prepared as illustrated in Reaction Scheme 1:

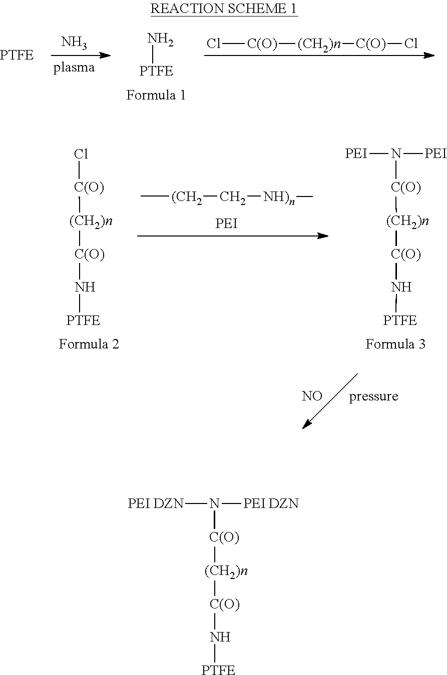

Formula 4

wherein PTFE is polytetrafluoroethylene, PEI is poly(ethyleneimine), DZN is a diazeniumdiolated group (NONO), and n is an integer between 0 and 20. A PTFE surface is first functionalized by attachment of amino groups to form a structure depicted in Formula 1. Although Formula 1 depicts one amino group attached to the PTFE surface, it should be understood that this is a simplification and that the PTFE surface would necessarily have multiple amino groups attached thereto. The amino functionalization is accomplished by subjecting the PTFE surface to a plasma discharge in the presence of ammonia (NH₃). This process is described, for example, in European Patent No. EP13658075B1, the contents of which are incorporated herein in their entirety. The radio frequency power can be 10 to 800 w depending on the configuration and plasma machine. The duration of the treatment can be 10 to 600 seconds. The pressure of ammonia can be 100 to 500 m Tor.

The amino-functionalized PTFE is then treated with a multi-acyl chloride such as diacyl chloride as shown in Reaction Scheme 1, wherein n is an integer between 0 and 20, more preferably between 6 and 12 and most preferably 8, i.e., the diacyl chloride is sebacoyl dichloride. This results in the compound of Formula 2. The process can be accomplished by dipping ammonia plasma treated ePTFE in a solution containing the acyl chloride. The solvent can be anhydrous THF, chloroform, methylene chloride, diethyl ether etc. The concentration range is 0.1 to 30%. Generally, the reaction between amine and the acyl chloride is very rapid. The reaction time can be 1 minute to 24 hours to ensure the reaction is complete. Alternatively, a base such as triethyl amine is added to absorb the hydrochloride generated.

The compound of Formula 2 is then reacted with poly(ethyleneimine) (PEI), or a copolymer containing ethyleneimine monomeric units, to form the compound of Formula 3 having the linking group —NH—C(O)—(CH₂)ₙ—C(O)—. Formula 3 represents a diazeniumdiolatable polymer. Again, it is understood that there will be multiple points of attachment of the PEI chain, through multiple linking groups, to the PTFE surface, although, for simplicity, only one point of attachment is illustrated. The process can be accomplished by dipping ePTFE, whose surface is grafted with acyl chloride groups, into a solution containing the PEI in the concentration of 1 to 20 weight % for 1 minute to 24 hours at room or elevated temperature up to 50° C. The solvent can be anhydrous THF, N,N-dimethylacetamide, N,N-dimethylformamide or N-methylpyrrolidinone.

In order to prepare a nitric oxide releasing polymer, the compound of Formula 3 is diazeniumdiolated by reaction with nitric oxide (NO) under pressure in the presence of base to yield the compound of Formula 4, wherein each diazeniumdiolate group (NONO) is represented by DZN. ePTFE with PEI grafted surface is pressured with nitric oxide gas at 20-500 psi for 1 to 5 days. Alternatively, the diazeniumdiolation can be accomplished by a solution method, for example, whereby an ePTFE sheet is immersed in a methanol solution containing 1 to 10% sodium methoxide under 20 to 500 psi nitric oxide pressure for 1 to 5 days.

The carbon-based diazeniumdiolated polymers of the present invention may be prepared as illustrated in Reaction Scheme 2:

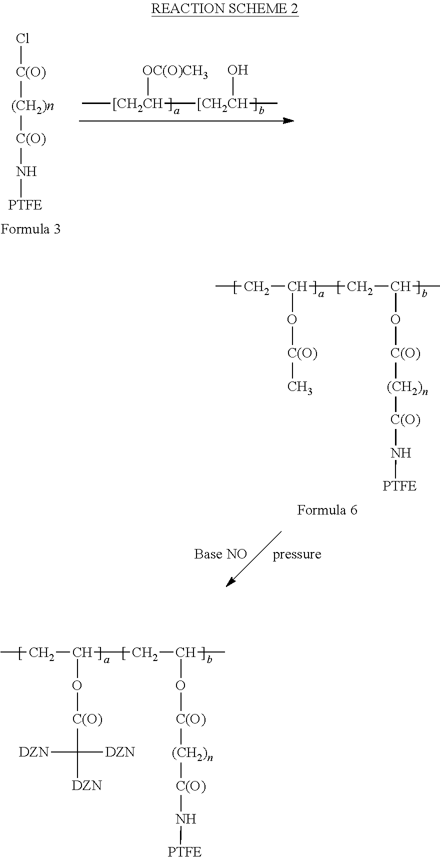

Formula 7

wherein PTFE is polytetrafluoroethylene, DZN is a diazeniumdiolate group (NONO), n is an integer between 0 and 20, and a and b are independently integers between 1 and 20,000.

In this scheme, the compound of Formula 3 is reacted with a copolymer comprising vinyl alcohol and vinyl acetate monomeric units to afford the compound of Formula 6, which is a diazeniumdiolatable polymer. Again, it is understood that there will be multiple points of attachment of the poly(vinyl alcohol)/poly(vinyl acetate) chain, through multiple linking groups, to the PTFE surface, although, for simplicity, only one point of attachment is illustrated. The grafting reaction can be carried out in THF with catalyst of pyridine at room or elevated temperature up to 100° C. under pressure. The concentration of the polymer to be grafted can be 1 to 30%.

In order to prepare a nitric oxide releasing polymer, the compound of Formula 6 is diazeniumdiolated by reaction with nitric oxide (NO) under pressure in the presence of base to yield the compound of Formula 7, wherein each diazeniumdiolate group (NONO) is represented by DZN.

In an exemplary embodiment, the polymers described herein are used to coat implantable medical devices deployed in a hemodynamic environment. As such, in some embodiments, the polymers possess excellent adhesive properties. That is, the coating has the ability to be stably coated on the medical device surface.

It should be noted that the medical device may be formed or coated with an already diazeniumdiolated polymer, such as the polymers of Formulas 4 or 7, or may be coated with a coating comprising a precursor diazeniumdiolatable polymer, such as the polymers of Formulas 3 or 6. In the latter case, the diazeniumdiolation may be performed on the already coated medical device.

The medical devices used may be permanent medical implants, temporary implants, or removable devices. For example, and not intended as a limitation, the medical devices may include stents, stent grafts, and vascular grafts.

In one embodiment, the medical device is a stent or stents. The stents may be vascular stents, urethral stents, biliary stents, or stents intended for use in other ducts and organ lumens. Vascular stents, for example, may be used in peripheral, cerebral, or coronary applications. The stents may be rigid expandable stents or pliable self-expanding stents. Many different materials can be used to fabricate the implantable medical devices including, but not limited to, stainless steel, nitinol, aluminum, chromium, titanium, gold, cobalt, alloys of the above, ceramics, and a wide range of synthetic polymeric and natural materials including, but not limited to, collagen, fibrin and plant fibers. All of these materials, and others, may be used with the polymeric coatings made in accordance with the teachings disclosed herein.

In another embodiment, the medical device is a stent graft. Typically, a stent graft for use in treating, for example, aortic aneurism, comprises a metallic frame, either throughout the length of the device or at each end. A fabric or polymeric sheath impervious to blood penetration covers the entire device. PTFE is commonly used as the material for such sheath. The polymers of the present invention provide an improved, more hemocompatible, surface and are therefore particularly useful as material for such sheaths.

In another embodiment the medical device is a vascular graft. Typically, vascular grafts comprise tube-like structures formed of fabric or polymer that are sewn in to replace a damaged or diseased section of a blood vessel. PTFE is a common material used for this purpose. The polymers of the present invention provide an improved, more hemocompatible, surface and are therefore particularly useful as material for forming such vascular grafts.

There are many theories that attempt to explain, or contribute to our understanding of how polymers adhere to surfaces. The most important forces include electrostatic and hydrogen bonding. However, other factors including wettability, absorption and resiliency also determine how well a polymer will adhere to different surfaces. Therefore, polymer base coats, or primers are often used in order to create a more uniform coating surface.

The polymers described herein when used as coatings can be applied to medical device surfaces, either primed or bare, in any manner known to those skilled in the art. Application methods for the polymeric coatings include, but are not limited to, spraying, dipping, brushing, vacuum-deposition, and the like. The polymeric coatings may also be applied as a sheet or sheath. Moreover, in some embodiments, the H₂S generating polymeric coatings may be used with a cap coat. A cap coat as used herein refers to the outermost coating layer applied over another coating.

In one embodiment, a primer coating is applied to the surface of a stent or other implantable medical device. Then a polymer coating is applied over the primer coat. Thereafter, a polymer cap coat may optionally be applied over the polymeric coating. The cap coat may optionally serve as a diffusion barrier to control the NO and/or bioactive agent release. The cap coat may be merely a biocompatible polymer applied to the surface of the sent to protect the stent and have no effect on the NO or bioactive agent release rates

Although it is within the scope of the present disclosure that additional bioactive agents can be useful in treating a plethora of medical conditions, in some exemplary embodiments, the use of a NO releasing polymer can alleviate the need for additional bioactive agents. The NO releasing polymers described herein have the effect of providing cardiovascular effects such as, but not limited to, vasodilatation, anti-inflammation and anti-restenosis. Therefore, medical devices incorporating NO releasing polymers or polymer systems can have the benefit of alleviating the need for supplemental bioactive agents to treat vasoconstriction, inflammation and restenosis. Removing such bioactive agents from a patient's post implantation treatment can help reduce side effects associated with the systemic, or even local, administration of such agents.

Additionally, removing such agents from systemic administration or local delivery from the same medical device can reduce the complexity of the treatment. For example, some bioactive agents may not work well together or may require separate polymer systems in order to achieve controlled release from the implanted device.

### EXAMPLES

The following Examples are intended to illustrate non-limiting processes for preparing biocompatible and hemocompatible polymers and using such polymers in implantable medical devices.

### Example 1

A 2×4 cm ePTFE sheet wrapped around a flat stainless metal strip was washed with HPLC grade methanol overnight. The cleaned sheet was dried in a vacuum at 60° C. overnight. The sheet was subjected to 600 W of RF plasma of 300 mTorr of high-purity ammonia at a frequency of 13.56 MHz for 240 s.

### Example 2

The ePTFE sheet from example 1 was stored in a glovebox and immersed in anhydrous THF solution containing 5% sebacoyl dichloride for one hour under agitation.

### Example 3

The sheet from example 2 was washed with anhydrous THF and then immersed in anhydrous THF solution containing 5% branched PEI polymer (Mn ca 10,000) under stirring overnight. The polymer was washed in THF and dried under vacuum.

### Example 4

The ePTFE sheet having a surface grafted with PEI from Example 3 is mounted in a Parr reactor, which is subjected to a vacuum/Argon cycle 10 times. The reactor is pressurized with 80 psi nitric oxide gas for 3 days at room temperature to afford a stent with a PTFE cover capable of releasing nitric oxide.

### Example 5

The ePTFE sheet having a surface grafted with acyl chloride functional groups (from Example 2) is immersed in a 10% solution of poly(vinyl alcohol-co-vinyl acetate) (5/95 molar ratio) in anhydrous THF containing 5% dried pyridine for 5 days. The ePTFE sheet is washed with THF three times and dried in a vacuum overnight.

### Example 6

An ePTFE covered Nitinol stent is plasma treated with 600 W of RF plasma of 300 mTorr of high-purity ammonia at a frequency of 13.56 MHz for 240 s. The stent is dipped into a 5% sebacoyl chloride solution in anhydrous THF for 30 minutes and rinsed with THF three times. Next, the stent is dipped into 15% branched PEI solution in THF overnight. The treated stent is washed with THF and dried in vacuum.

### Example 7

The stent from example 6 is mounted on a mandrel in a Parr reactor. The reactor is subjected to vacuum/Argon cycles ten times before being pressured with 80 psi nitric oxide gas for three days at room temperature to afford a stent with a PTFE cover capable of releasing nitric oxide.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a” and “an” and “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments of this invention are described herein, including the best mode known to the inventors for carrying out the invention. Of course, variations on those preferred embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above cited references and printed publications are herein individually incorporated by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

Specific embodiments disclosed herein may be further limited in the claims using consisting of or and consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

What is claimed is:

1. A biocompatible and hemocompatible polymer adapted for use in an implantable medical device, comprising:
a. a PTFE surface;
b. a linking group covalently bound to said surface; and
c. a nitric oxide releasing polymer, said polymer covalently bound to said linking group.

2. The polymer of claim 1 wherein said nitric oxide releasing polymer comprises diazeniumdiolated poly(ethyleneimine) or a copolymer of poly(vinyl alcohol) and diazeniumdiolated poly(vinyl acetate).

3. The polymer of claim 1 wherein said linking group has the formula —NH—C(O)—(CH₂)ₙ—C(O)—, wherein n is an integer of from 0 to 20 and wherein the nitrogen of said linking group is covalently bound to the PTFE surface.

4. The polymer of claim 3 wherein n is 8.

5. The polymer of claim 1 wherein the nitric oxide releasing polymer comprises at least one additional monomer unit.

6. An implantable medical device comprising a biocompatible and hemocompatible polymer comprising:
a. a PTFE surface;
b. a linking group covalently bound to said surface; and
c. a nitric oxide releasing polymer, said polymer covalently bound to said linking group.

7. The medical device of claim 6 wherein said nitric oxide releasing polymer comprises diazeniumdiolated poly(ethyleneimine) or a copolymer of poly(vinyl alcohol) and diazeniumdiolated poly(vinyl acetate).

8. The medical device of claim 6 wherein said linking group has the formula —NH—C(O)—(CH₂)ₙ—C(O)—, wherein n is an integer of from 0 to 20 and wherein the nitrogen of said linking group is covalently bound to the PTFE surface.

9. The medical device of claim 8 wherein n is 8.

10. The medical device of claim 6 selected from the group consisting of stents, stent grafts and vascular grafts.

11. The medical device of claim 6 wherein the nitric oxide releasing polymer comprises at least one additional monomer unit.

12. A polymer adapted for use in an implantable medical device, comprising:
a. a PTFE surface;
b. a linking group covalently bound to said surface; and
c. a diazeniumdiolatable polymer, said polymer covalently bound to said linking group.

13. The polymer of claim 12 wherein said diazeniumdiolatable polymer comprises poly(ethyleneimine) or a copolymer of poly(vinyl alcohol) and poly(vinyl acetate).

14. The polymer of claim 12 wherein said linking group has the formula —NH—C(O)—(CH₂)ₙ—C(O)—, wherein n is an integer of from 0 to 20 and wherein the nitrogen of said linking group is covalently bound to the PTFE surface.

15. The polymer of claim 14 wherein n is 8.

16. The polymer of claim 12 wherein the diazeniumdiolatable polymer comprises at least one additional monomer unit.

17. An implantable medical device comprising a polymer comprising:
a. a PTFE surface;
b. a linking group covalently bound to said surface; and
c. a diazeniumdiolatable polymer, said polymer covalently bound to said linking group.

18. The medical device of claim 17 wherein said diazeniumdiolatable polymer comprises poly(ethyleneimine) or a copolymer of poly(vinyl alcohol) and poly(vinyl acetate).

19. The medical device of claim 17 wherein said linking group has the formula —NH—C(O)—(CH₂)ₙ—C(O)—, wherein n is an integer of from 0 to 20 and wherein the nitrogen of said linking group is covalently bound to the PTFE surface.

20. The medical device of claim 19 wherein n is 8.

21. The medical device of claim 17 selected from the group consisting of stents, stent grafts and vascular grafts.

22. The medical device of claim 17 wherein the diazeniumdiolatable polymer comprises at least one additional monomer unit.

23. A process for preparing a polymer of the formula 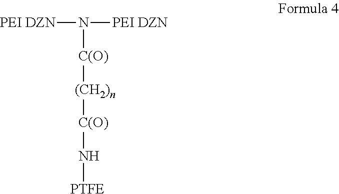
wherein PTFE is polytetrafluoroethylene, PEI is poly(ethyleneimine), DZN is a diazeniumdiolate group (NONO) and n is an integer between 0 and 20, the process comprising:
a. treating a PTFE surface with ammonia in a plasma discharge to form a compound of Formula 1; 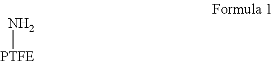
b. reacting the compound of Formula 1 with a diacyl dichloride
Cl—C(O)—(CH₂)ₙ—C(O)—Cl
wherein n is as above, to form a compound of Formula 2; 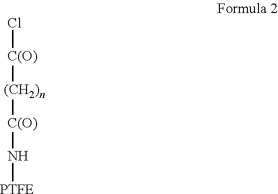
c. reacting the compound of Formula 2 with a polymer comprising poly(ethyleneimine) to form a compound of Formula 3; and 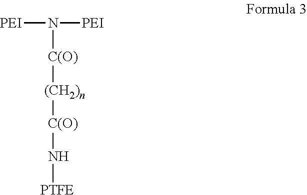
d. reacting the compound of Formula 3 with nitric oxide.

24. The process of claim 23 wherein n is 8.

25. A process for preparing a polymer of the formula 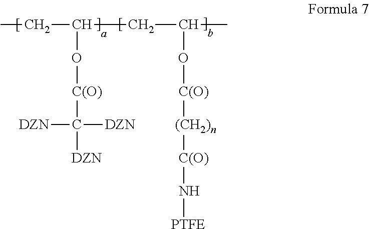
wherein PTFE is polytetrafluoroethylene, DZN is a diazeniumdiolated group (NONO), n is an integer between 0 and 20 and a and b are independently integers between about 1 and 20,000, the process comprising:
a. treating a PTFE surface with ammonia in a plasma discharge to form a compound of Formula 1; 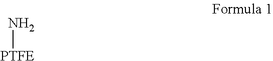
b. reacting the compound of Formula 1 with a diacyl dichloride
Cl—C(O)—(CH₂)ₙ—C(O)—Cl
wherein n is as above, to form a compound of Formula 2; 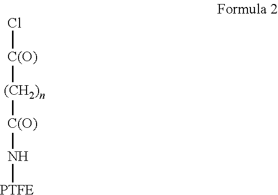
c. reacting the compound of Formula 2 with a copolymer comprising vinyl alcohol and vinyl acetate monomeric units 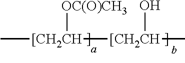
wherein a and b are as above, to form a compound of Formula 6; and 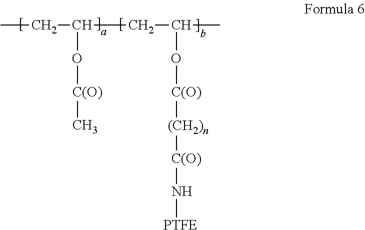
d. reacting the compound of Formula 6 with nitric oxide.

26. The process of claim 25 wherein n is 8.
